(19) United States
(12) Patent Application Publication
(10) Pub. No.: US 2014/0054152 A1
(43) Pub. Date: Feb. 27, 2014

(54) TOUCH PANEL AND TOUCH DISPLAY APPARATUS USING SAME

(71) Applicant: TIANJIN FUNAYUANCHUANG TECHNOLOGY CO.,LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 13/972,953

(22) Filed: Aug. 22, 2013

(30) Foreign Application Priority Data
Aug. 24, 2012 (CN) 201210304614X

(51) Int. Cl. H01H 13/807

(52) U.S. Cl. CPC H01H 13/807; Y10S 977/956; B82Y 15/00
USPC 200/5 A; 977/956

(57) ABSTRACT

A touch panel includes a first sub-panel and a second sub-panel. Each of the first sub-panel and the second sub-panel comprises a carbon nanotube (CNT) film and defines a touch sensing region and a first side region connecting a first side of the touch sensing region. The first side region is bent towards the touch sensing region and an intersection angle is formed between the side region and the touch sensing region. The first side region of the first sub-panel is attached to the first side region of the second sub-panel such that the touch sensing region of the first sub-panel and the touch sensing region of the second sub-panel are located in a same plane and joined together.

### CROSS-REFERENCE TO RELATED APPLICATIONS

This application claims all benefits accruing under 35 U.S.C. §119 from China Patent Application No. 201210304614.X, filed on Aug. 24, 2012 in the China Intellectual Property Office, the content of which is hereby incorporated by reference in its entirety. This application is related to commonly-assigned applications entitled, “CARBON NANOTUBE TOUCH PANEL AND TOUCH DISPLAY APPARATUS USING SAME” filed ______ (Atty. Docket No. US46684), “CARBON NANOTUBE TOUCH PANEL HAVING TWO CARBON NANOTUBE FILMS” filed ______ (Atty. Docket No. US46691), “CARBON NANOTUBE TOUCH PANEL HAVING AT LEAST TWO CARBON NANOTUBE FILMS” filed ______ (Atty. Docket No. US46692), “CARBON NANOTUBE TOUCH PANEL AND METHOD FOR MAKING SAME” filed ______ (Atty. Docket No. US46693), “CARBON NANOTUBE TOUCH PANEL AND TOUCH DISPLAY APPARATUS USING SAME” filed ______ (Atty. Docket No. US46694), and “TOUCH PANEL AND TOUCH DISPLAY APPARATUS USING SAME” filed ______ (Atty. Docket No. US46695).

### BACKGROUND

1. Technical Field

The present disclosure relates to touch sensing technologies, and more particularly, to a touch panel with at least one carbon nanotube (CNT) film and a touch display apparatus using the touch panel.

2. Description of Related Art

Touch display apparatuses normally include a display assembly and a touch panel attached to the display assembly. Carbon nanotube (CNT) touch panels are widely used because of the durability of CNT touch panels. A CNT touch panel includes a plurality of carbon nanotubes arranged in parallel on a substrate. However, conductivity of the carbon nanotubes decrease as a length of the CNT unit increases. This characteristic is a limit in design, and making a CNT touch panel with a large size is problematic.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic view of a touch panel according to a first embodiment of the present disclosure, the touch panel including a first sub-panel and a second sub-panel.

FIG. 2 is an exploded view of the touch panel of FIG. 1.

FIG. 3 is an exploded view of the first sub-panel of FIG. 1.

FIG. 4 is an exploded view of the second sub-panel of FIG. 1.

FIG. 5 is a detailed plan view of the touch panel of FIG. 2.

FIG. 6 is a schematic view of a CNT film of the touch panel of FIG. 1.

FIG. 7 is a detailed plan view of the touch panel of FIG. 1.

FIG. 8 is a transparent conductive layer of the first sub-panel or the second sub-panel of a touch panel according to an alternative embodiment of the present disclosure.

FIG. 9 is an exploded view of a touch panel according to a second embodiment of the present disclosure.

FIG. 10 is a schematic view of the touch panel of FIG. 9.

FIG. 11 is a plan view of a touch panel according to a third embodiment of the present disclosure, the touch panel including a first sub-panel and a second sub-panel.

FIG. 12 is an exploded view of the first sub-panel of FIG. 11.

FIG. 13 is an exploded view of the second sub-panel of FIG. 11.

FIG. 14 is a schematic view of a touch display apparatus according to an embodiment of the present disclosure.

### DETAILED DESCRIPTION

Reference will be made to the drawings to describe various embodiments.

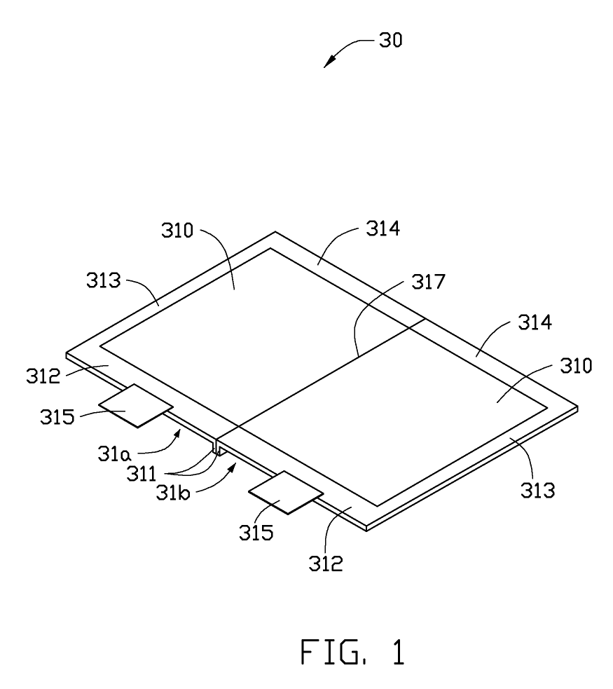

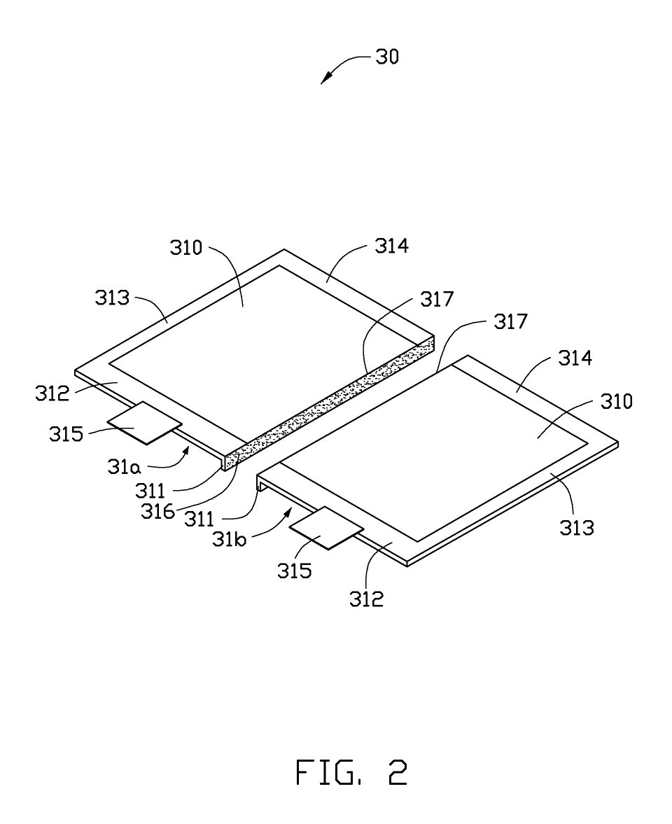

Referring to FIGS. 1-2, a touch display apparatus 10 according to a first embodiment of the present disclosure includes a first sub-panel 11a and a second sub-panel 11b. In the embodiment, both of the first sub-panel 11a and the second sub-panel 11b are CNT touch panels and include a CNT film.

Each of the first sub-panel 11a and the second sub-panel 11b includes a touch sensing region 110, a first side region 111, a second side region 112, a third side region 113, a fourth side region 114 and a flexible printed circuit (FPC) 115. The touch sensing region 110 is located in a main central region of the CNT sub-panel 11a or 11b. The first side region 111, the second side region 112, a third side region 113, and the fourth side region 114 are connected four sides of the touch sensing region 110 respectively. The first side region 111, the second side region 112, a third side region 113, and the fourth side region 114 are arranged end to end to form a periphery region surrounding the touch sensing region 110. The FPC 115 is mounted on and electrically connected to an edge of the second side region 112. The first side region 111 and the third side region 113 are located adjacent to two opposite ends of the touch sensing region 110. The second side region 112 and the fourth side region 114 are located adjacent to the other two opposite ends of the touch sensing region 110.

The first side region 111 is bent towards the touch sensing region 110 and an intersection angle is formed between the first side region 111 and the touch sensing region 110. In the embodiment, the intersection angle is 90 degrees, that is, the first side region 111 is perpendicular to the touch sensing region 110. The first side region 111 of the first sub-panel 11a is adjacent to the first side region 111 of the second sub-panel 11b and is attached to the first side region 111 of the second sub-panel 11b by an adhesive layer 116, such that the touch sensing region 110 of the first sub-panel 11a and the touch sensing region 110 of the second sub-panel 11b are located on a same plane and joined. Furthermore, the second side region 112 of the first sub-panel 11a and the second side region 112 of the second sub-panel 11b are located on the same plane and joined. In addition, the fourth side region 114 of the first sub-panel 11a and the fourth side region 114 of the second sub-panel 11b are located on the same plane and joined.

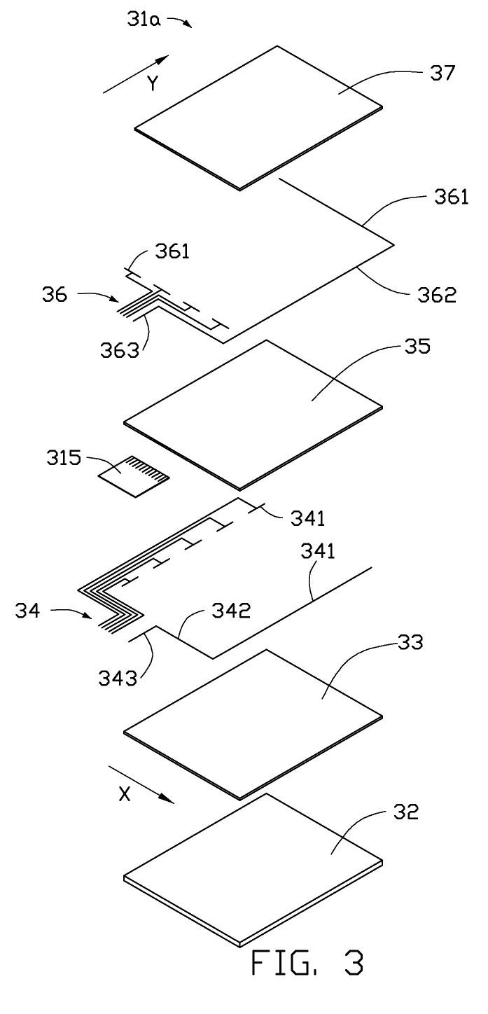

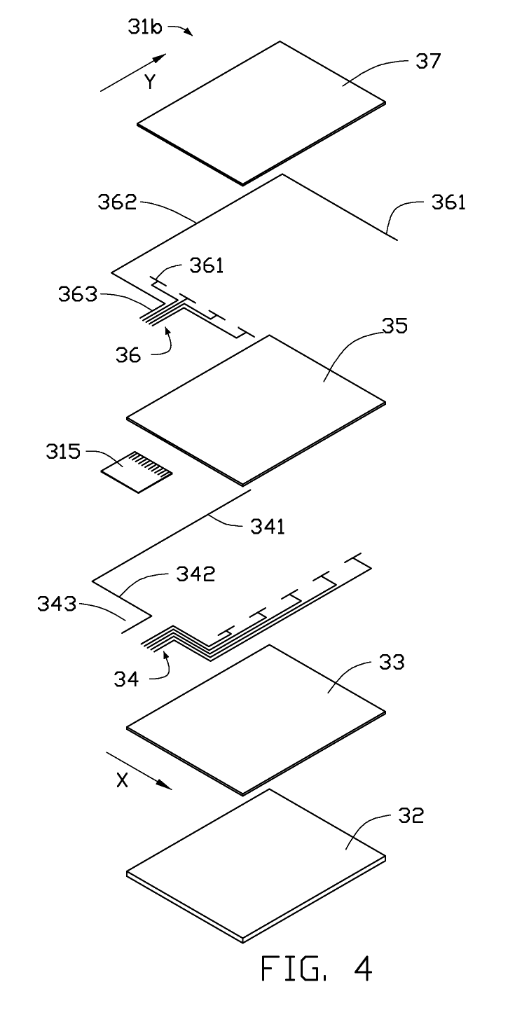

Referring to FIG. 3 and FIG. 4, both of the first sub-panel and the second sub-panel includes a base 32, a first CNT film 33, a plurality of first connection wires 34, an insulation layer 35, a transparent conductive layer 37, and a plurality of second connection wires 36. The base 32 may be a transparent glass or a transparent plastic substrate. The first CNT film 33 is positioned on the base 32. The first connection wires 34 are configured to electrically connect between the first CNT film 33 and the FPC 315. The second connection wires 36 are configured to electrically connect between the transparent conductive layer 37 and the FPC 315. The insulation layer 35 is sandwiched between the first CNT film 33 and the transparent conductive layer 37, such that the first CNT film 33 and the transparent conductive layer 37 coordinately define a capacitance-type touch sensing structure.

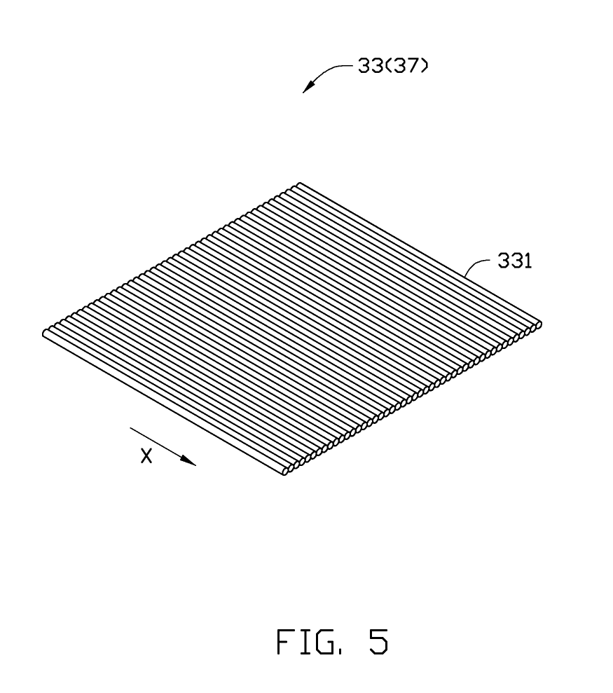

In the embodiment, the transparent conductive layer 37 is a second CNT film. Referring to FIG. 5, each of the first CNT film 33 and the second CNT film of transparent conductive layer 37 includes a plurality of carbon nanotubes 331 orderly arranged along a same direction. In detail, each carbon nanotube 331 of the first CNT film 33 extends along a first direction X, and each carbon nanotube 331 of the first CNT film 33 extends along a second direction Y perpendicular to the first direction X.

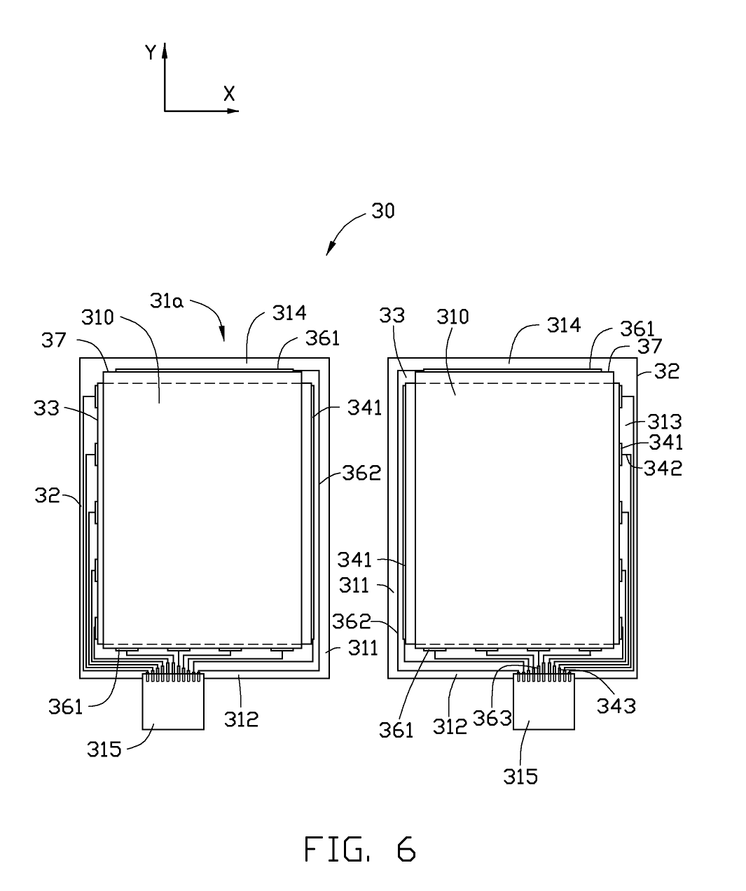

FIG. 6 shows that a detailed plan view of the touch panel 30 before the first side region 311 of the first sub-panel 31a is attached to the first side region 311 of the second sub-panel 31b. The first CNT sub-panel 31a has a configuration substantially the same as the second CNT sub-panel 31b, but differs in that a location of the first side region 311 and the third side region 313 in the first sub-panel 31a is opposite to a location of the first side region 311 and the third side region 313 in the second sub-panel 31b. For example, in the first sub-panel 31a, the first side region 311 is located in a right side of the touch sensing region 310, and the third side region 313 is located in a left side of the touch sensing region 310. In the second sub-panel 31b, the first side region 311 is located in a left side of the touch sensing region 310, and the third side region 313 is located in a right side of the touch sensing region 310.

Both of the first CNT film 33 and the transparent conductive layer 37 cover the touch sensing region 310. The plurality of first connection wires 34 are positioned on the periphery region surrounding the touch sensing region 310 and are electrically coupled between the first CNT film 33 and the FPC 315. The plurality of second connection wires 36 are positioned on the periphery region surrounding the touch sensing region 310 and are electrically coupled between the transparent conductive layer 37 and the FPC 315.

Each first connection wire 34 includes a first electrode 341 electrically connected to the first CNT film 33, a second electrode 343 electrically connected to the FPC 315, and a first connection portion 342 connected between the first electrode 341 and the second electrode 343. In the embodiment, the first electrodes 341 are positioned on the first side region 311 and the third side region 313, and the second electrodes 342 are positioned on the second side region 312. In the embodiment, the first side region 311 has a first electrode 341 arranged along the second direction Y, and the first electrode 311 of the first side region 311 extends from an end of the first side region 311 to the opposite end of the first side region 311. The third side region 313 has a plurality of first electrodes 341 arranged along the second direction Y. The second side region 312

[symbol]

Each second connection wire 36 includes a third electrode 361 electrically connected to the transparent conductive layer 37, a fourth electrode 363 electrically connected to the FPC 315, and a second connection portion 362 connected between the third electrode 361 and the fourth electrode 363. In the embodiment, the third electrodes 361 are positioned on the second side region 312 and the fourth side region 314, and the fourth electrodes 363 are positioned on the second side region 312. In the embodiment, the second side region 312 includes a plurality of third electrodes 361 arranged along the first direction X. The fourth side region 314 has a third electrode 361 extending along the first direction X, and the third electrode 361 of the fourth side region 314 extends from an end of the fourth side region 314 to the opposite end of the fourth side region 314.

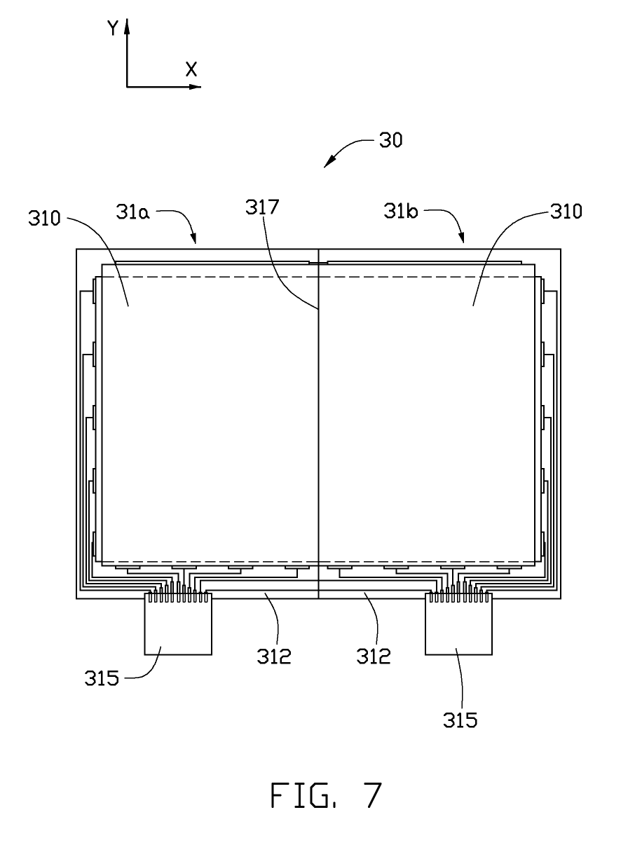

FIG. 7 shows that a detailed plan view of the touch panel 30 after the first side region 311 of the first sub-panel 31a is attached to the first side region 311 of the second sub-panel 31b. The touch sensing region 310 includes a side line 317 adjacent to the first side region 311, and the side line 317 is parallel to the second direction Y. It can be seen that, the touch sensing region 310 of the first sub-panel 31a and the touch sensing region 310 of the second sub-panel 31b are joined to form a large touch sensing region of the touch panel 30. The second side region 312 of the first sub-panel 31a and the second side region 312 of the second sub-panel 31b are joined, and the two FPCs 315 extend out from a same side of the touch panel 30.

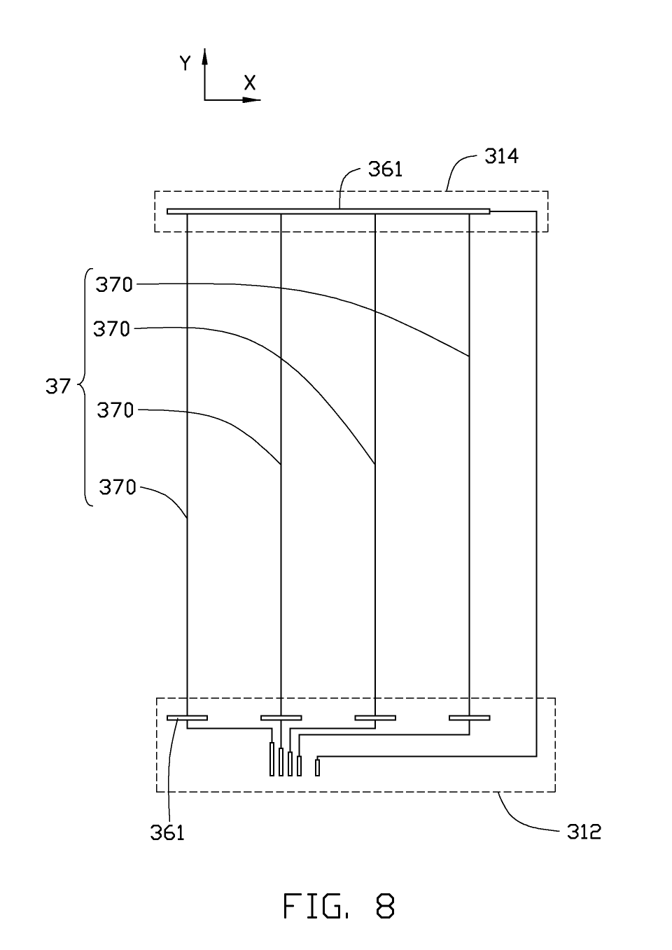

FIG. 8 shows that a structure of a transparent conductive layer 37 of the first sub-panel 31a or the second sub-panel 31b of a touch panel 30 according to an alternative embodiment. In the alternative embodiment, the transparent conductive layer 37 may be not a CNT film, but includes a plurality of transparent electrodes 370 each extending along the second direction Y. The transparent electrodes 370 are made from indium tin oxide (ITO) or indium zinc oxide (IZO). One end of the transparent electrode 370 is electrically connected to the third electrode 361 of the fourth side region 341, and the other end of the transparent electrode 370 is electrically connected to the third electrode 361 of the second side region 312.

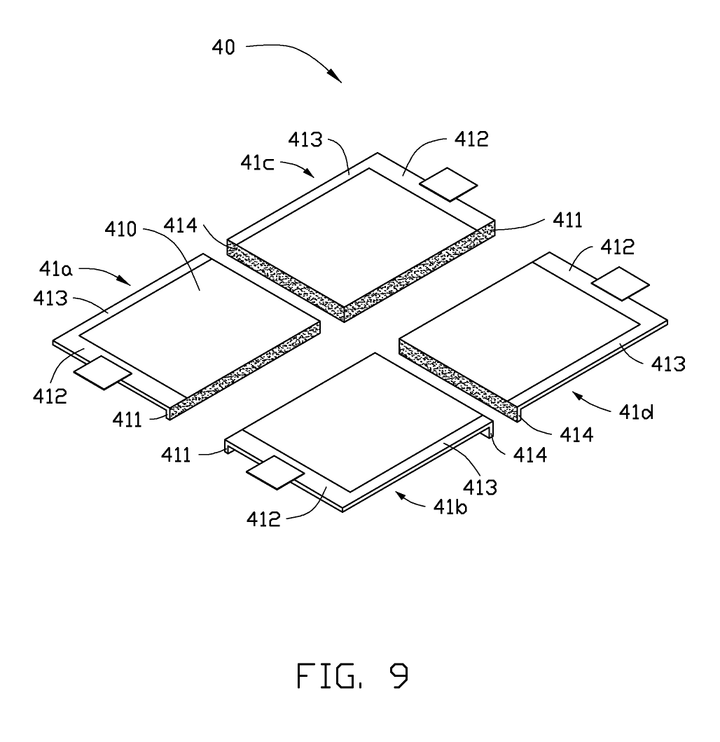

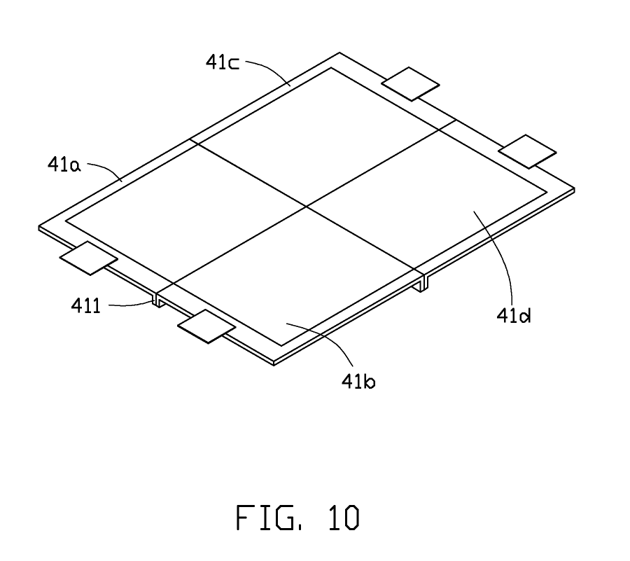

Referring to FIG. 9 and FIG. 10, a touch panel 40 according to a third embodiment of the present disclosure is similar to the above-described touch panel 10 according to the first embodiment, but differs in the following aspects: the touch panel 40 further includes a third sub-panel 41c and a fourth sub-panel 41d. In detail, each of the third sub-panel 41c and the fourth sub-panel 41d comprises a touch sensing region 410, a first side region 411, a second side region 412 adjacent to the first side region 411, a third side region 413 opposite to the first side region 411, a fourth side region 414 opposite to the second side region 412, and a FPC 415 connected to the second side region 412. The fourth side region 414 of each of the first, the second, the third and the fourth sub-panels 41a, 41b, 41c and 41d are perpendicular to the corresponding touch sensing region 410. The fourth side region 414 of the third sub-panel 41c is adhered to the fourth side region 414 of the first sub-panel 41a, the fourth side region 414 of the fourth sub-panel 41d is adhered to the fourth side region 414 of the second sub-panel 41b, and the first side region 411 of the third sub-panel 41c is adhered to the first side region 411 of the fourth sub-panel 41d.

In the third embodiment, the four touch sensing regions 410 of the four sub-panels 41a, 41b, 41c and 41d are joined to form a large sensing region of the touch panel 40. The third side region 413 of the first sub-panel 41a and the third side region 413 of the third sub-panel 41c are joined. The third side region 413 of the second sub-panel 41b and the third side region 413 of the fourth sub-panel 41d are joined. The second side region 412 of the first sub-panel 41a and the second side region 412 of the second sub-panel 41b are joined, and the second side region 412 of the third sub-panel 41c and the second side region 412 of the fourth sub-panel 41d are joined

Moreover, it can be understood, each of the third sub-panel 41c and the fourth sub-panel 41d also has a first CNT film covering the corresponding touch sensing region 110, and the carbon nanotubes of the four first CNT films of the four sub-panels 41a, 41b, 41c and 41d extend along a same direction.

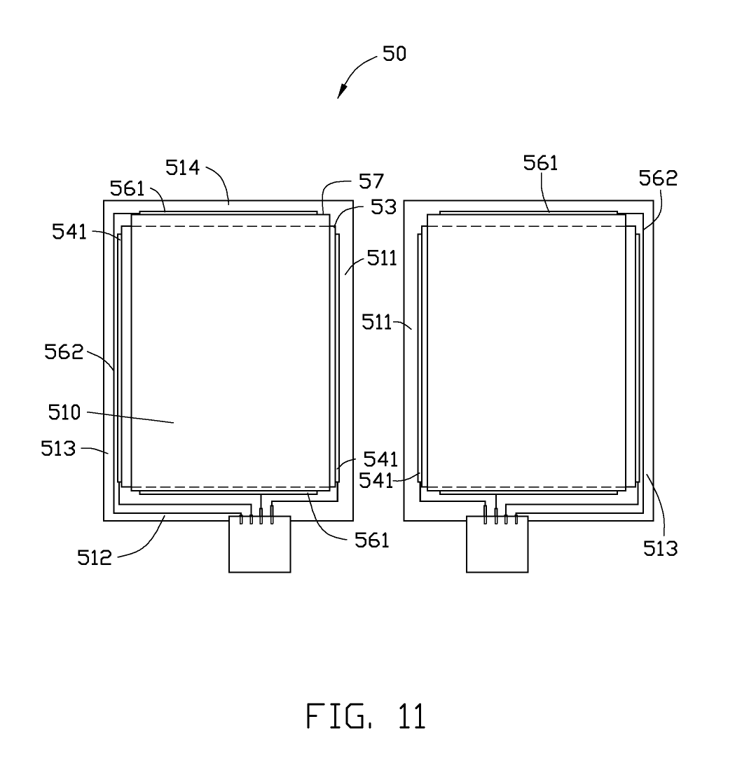

FIG. 11 shows that a detailed plan view of a touch panel 50 according to a third embodiment. In FIG. 11, the first side region 511 has not been bent towards the touch sensing region 510, and the first side region 511 of the first sub-panel 51a has not been attached to the first side region 511 of the second sub-panel 51b. The touch panel 50 is similar to the above-described touch panel 30 according to the first embodiment, but differs in the following aspects: a first CNT film 53 and a transparent conductive layer 57 coordinately define a resistance-type touch sensing structure, and the connection wires between the first CNT film 53, the transparent conductive layer 57, and a FPC 515 is different from the connection wires 34 and 36 according to the first embodiment.

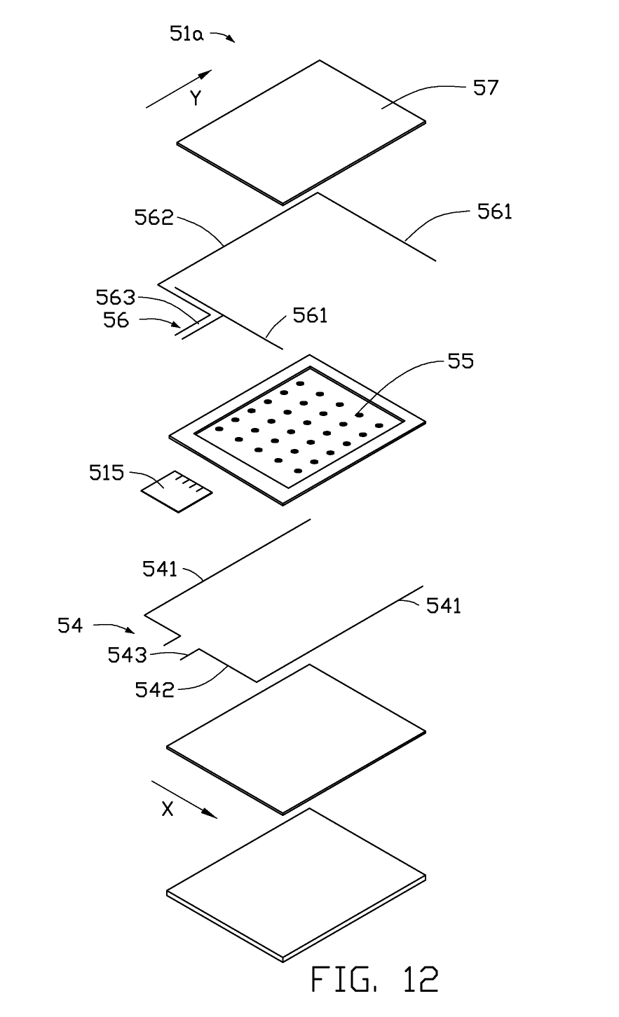

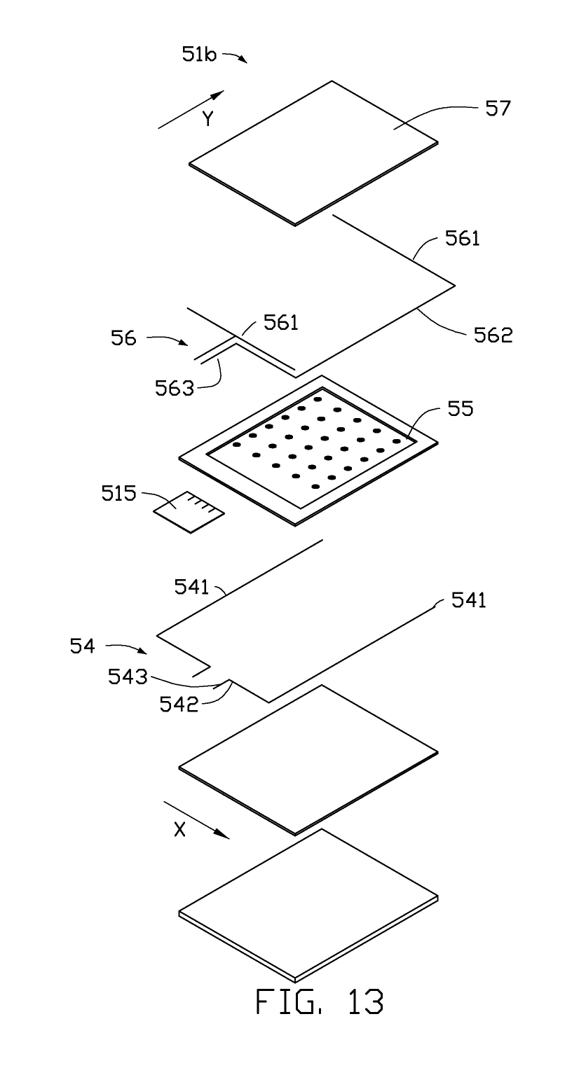

FIG. 12 and FIG. 13 show that each of the first sub-panel 51a and the second sub-panel 51b includes a spacer layer 55 sandwiched between the first CNT film 53 and the transparent conductive layer 57, such that the first CNT film 53 and the transparent conductive layer 57 coordinately define a resistance-type touch sensing structure. Each of the first sub-panel 51a and the second sub-panel 51b includes two first connection wires 54 and two second connection wires 56. Each first connection wire 54 includes a first electrode 541 connecting the first CNT film 53, a second electrode 543 connecting the FPC 515 and a first connection portion 542 connected between the first electrode 541 and the second electrode 543. Each second connection wire 56 includes a third electrode 561 connecting the transparent conductive layer 57, a fourth electrode 563 connecting the FPC 515 and a second connection portion 562 connected between the third electrode 561 and the fourth electrode 563.

In the embodiment, one first electrode 541 of the two first connection wires 54 is located in the first side region 511, the other one first electrode 541 of the two first connection wires 54 is located in the third side region 513. One of the third electrodes 561 of the two second connection wires 56 is located in the second side region 512, the other one of the third electrodes 561 of the two second connection wires 56 is located in the fourth side region 514. Moreover, the third electrodes 561 extend along a first direction X, the first electrodes 541 extend along a second direction Y perpendicular to the first direction X. Each of the first, the second, the third and the fourth electrodes 541, 543, 561 and 563 extends from an end of a corresponding one side region 511, 512, 513 and 514 to an opposite end of the corresponding one side region 511, 512, 513 and 514. The second connection portion 562 connected to the third electrode 561 of the fourth side region 514 is located in the fourth, the third and the second side regions 514, 513 and 512.

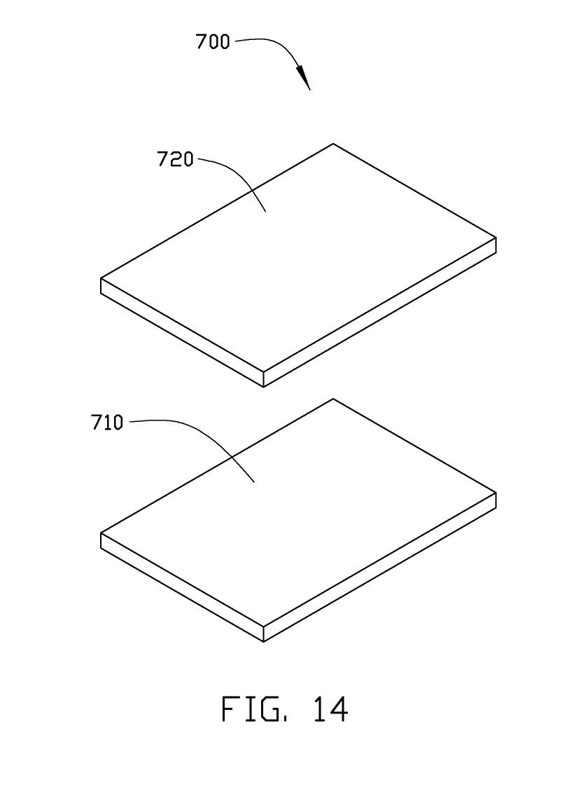

FIG. 14 shows that a touch display apparatus 700 according to an embodiment of the present disclosure. The touch display apparatus 700 includes a display panel 710 and a touch panel 720 positioned above the display panel 710. The touch panel 720 may be adopted the above touch panel 30, 40 and 50. The display panel 520 may be a liquid crystal display (LCD) panel, an organic light Emitting diode (OLED) display panel or a plasma display panel (PDP).

It is to be understood that even though numerous characteristics and advantages of the present embodiments have been set forth in the foregoing description, together with details of the structures and functions of the embodiments, the disclosure is illustrative only; and that changes may be made in detail, especially in the matters of shape, size, and arrangement of parts, within the principles of the embodiments, to the full extent indicated by the broad general meaning of the terms in which the appended claims are expressed.

What is claimed is:

1. A touch panel, comprising:
a first sub-panel and
a second sub-panel;
wherein each of the first sub-panel and the second sub-panel comprises a first carbon nanotube (CNT) film and defines a touch sensing region and a first side region connecting a first side of the touch sensing region, the first side region is bent towards the touch sensing region and an intersection angle is formed between the first side region and the touch sensing region; the first side region of the first sub-panel is attached to the first side region of the second sub-panel such that the touch sensing region of the first sub-panel and the touch sensing region of the second sub-panel are located in a same plane and joined together.

2. The touch panel of claim 1, wherein an external surface of the first side region is adhered to an external surface of the second side region by an adhesive layer.

3. The touch panel of claim 1, wherein the side region is perpendicular to the touch sensing region.

4. The touch panel of claim 1, wherein each of the first sub-panel and the second sub-panel further defines a second side region connecting a second side of the touch sensing region, a third side region connecting a third side of the touch sensing region, and a fourth side region connecting a fourth side of the touch sensing region, the first side region is positioned adjacent to the second side region and opposite to the third side region, the second side region side region is positioned opposite to the fourth side region and adjacent to the third side region, and each of the first sub-panel and the second sub-panel further comprising a flexible printed circuit (FPC) electrically connecting the second side region.

5. The touch panel of claim 4, wherein each of the first sub-panel and the second sub-panel further comprises a transparent conductive layer, at least one first connection wire and at least one second connection wire, the first CNT film and the transparent conductive layer coordinately define a touch sensing structure covering the touch sensing region, the at least one first connection wires is connected between the first CNT film and the FPC, the at least one second connection wires is connected between the transparent conductive layer and the FPC, and the first CNT film comprises a plurality of carbon nanotubes orderly arranged along a first direction.

6. The touch panel of claim 5, wherein the transparent conductive layer is a second CNT film, and the second CNT film comprises a plurality of carbon nanotubes orderly arranged along a second direction perpendicular to the first direction.

7. The touch panel of claim 5, wherein the transparent conductive layer comprises a plurality of transparent electrodes each extending along a second direction perpendicular to the first direction.

8. The touch panel of claim 7, wherein the transparent electrodes are made from indium tin oxide (ITO) or indium zinc oxide (IZO).

9. The touch panel of claim 5, wherein the touch sensing region comprises a side line connecting the first side region, and the side line is parallel to a second direction perpendicular to the first direction.

10. The touch panel of claim 5, wherein each of the first sub-panel and the second sub-panel further comprises an insulation layer sandwiched between the first CNT film and the transparent conductive layer, such that the first CNT film and the transparent conductive layer coordinately define a capacitance-type touch sensing structure.

11. The touch panel of claim 10, wherein the at least one first connection wire comprises a plurality of first connection wires, the at least one second connection wire comprises a plurality of second connection wires, each first connection wire comprises a first electrode connecting the first CNT film, a second electrode connecting the FPC and a first connection portion connected between the first electrode and the second electrode, and each second connection wire comprises a third electrode connecting the transparent conductive layer, a fourth electrode connecting the FPC and a second connection portion connected between the third electrode and the fourth electrode.

12. The touch panel of claim 11, wherein the plurality of first electrodes of the first connection wires are located in the first side region and the third side region, where the third side region comprises a plurality of first electrodes arranged along a second direction perpendicular to the first direction, and the first side region comprises a first electrode arranged along the second direction, and the first electrode of the first side region extends from an end of the first side region to the opposite end of the first side region.

13. The touch panel of claim 12, wherein the plurality of second electrodes of the first connection wires and the plurality of fourth electrodes of the second connection wires are located in the second side region, the plurality of third electrodes of the second connection wires are located in the second side region and the fourth side region, where the second side region comprises a plurality of third electrodes arranged along the first direction, the third side region comprises a third electrode arranged along the first direction, and the third electrode of the third side region extends from an end of the third side region to the opposite end of the third side region.

14. The touch panel of claim 5, wherein each of the first sub-panel and the second sub-panel comprises a spacer layer sandwiched between the between the first CNT film and the transparent conductive layer, such that the first CNT film and the transparent conductive layer coordinately define a resistance-type touch sensing structure.

15. The touch panel of claim 14, wherein the at least one first connection wire comprises two first connection wires, the at least one second connection wire comprises two second connection wires, each first connection wire comprises a first electrode connecting the first CNT film, a second electrode connecting the FPC and a first connection portion connected between the first electrode and the second electrode, each second connection wire comprises a third electrode connecting the transparent conductive layer, a fourth electrode connecting the FPC and a second connection portion connected between the third electrode and the fourth electrode, one first electrode of the two first connection wires is located in the first side region, the other one first electrode of the two first connection wires is located in the third side region, one third electrode of the two second connection wires is located in the second side region, the other one third electrode of the two second connection wires is located in the fourth side region, and the second electrodes and the fourth electrodes are located in the second side region.

16. The touch panel of claim 15, wherein the first electrodes extend along a second direction perpendicular to the first direction, the third electrodes extend along the first direction, and each of the first, the second, the third and the fourth electrodes extends from an end of a corresponding one side region to an opposite end of the corresponding one side region.

17. The touch panel of claim 16, wherein the second connection portion connected to the third electrode of the fourth side region is located in the fourth, the third and the second side region.

18. The touch panel of claim 5, wherein further comprising a third sub-panel and a fourth sub-panel, wherein each of the third sub-panel and the fourth sub-panel comprises a touch sensing region, a first side region, a second side region adjacent to the first side region, a third side region opposite to the first side region, a fourth side region opposite to the second side region, and a FPC connected to the second side region, the fourth side region of each of the first, the second, the third and the fourth sub-panels are is perpendicular to the corresponding touch sensing region, the fourth side region of the third sub-panel is attached to the fourth side region of the first sub-panel, the fourth side region of the fourth sub-panel is attached to the fourth side region of the second sub-panel, and the first side region of the third sub-panel is attached to the first side region of the fourth sub-panel, such that the four touch sensing regions of the four sub-panels are located in the same plane and joined.

19. A touch display apparatus, comprising:
a display panel; and
a touch panel positioned above the display panel, the touch panel comprising:
a first sub-panel and
a second sub-panel;
wherein each of the first sub-panel and the second sub-panel comprises a first carbon nanotube (CNT) film and defines a touch sensing region and a first side region connecting a first side of the touch sensing region, the first side region is bent towards the touch sensing region and an intersection angle is formed between the first side region and the touch sensing region, the first side region of the first sub-panel is attached to the first side region of the second sub-panel such that the touch sensing region of the first sub-panel and the touch sensing region of the second sub-panel are located on a same plane and joined together.

20. The touch display apparatus of claim 19, wherein the first side region is adhered to the second side region by an adhesive layer, and the first side region perpendicularly connects the touch sensing region.
